(19) United States
(12) Patent Application Publication
(10) Pub. No.: US 2016/0085544 A1
(43) Pub. Date: Mar. 24, 2016

(54) DATA MANAGEMENT SYSTEM

(71) Applicant: Microsoft Corporation, Redmond, WA (US)

(72) Inventors: Pankaj Sharma, Redmond, WA (US); Arabinda Mohapatra, Sammamish, WA (US); Alexander Berger, Sammamish, WA (US); Mangesh Ganpatrao Barad, Bellevue, WA (US); Veerendra K. Koya, Issaquah, WA (US); David M. Denz, Campbell River (CA); Tomer Weisberg, Redmond, WA (US); Mario Zimmermann, Redmond, WA (US); Brent Thomas McBride, Duvall, WA (US); Hema Tulsidas Goyal, Bellevue, WA (US); AnandBalaji Subbaraj, Sammamish, WA (US); Harinarayan Paramasivan, Redmond, WA (US); Ricardo Persegani, Sammamish, WA (US); Maxim Kudryavtsev, Redmond, WA (US)

(21) Appl. No.: 14/491,753

(22) Filed: Sep. 19, 2014

(51) Int. Cl. G06F 9/44

(52) U.S. Cl. CPC G06F 8/70

(57) ABSTRACT

Systems and techniques are disclosed for improving the management of data contracts during a software development lifecycle. A system can include a data contract metadata store, components for interacting with the metadata store to support development tool integration, and interchange features for verified build processes. A service can be provided that receives a developer package from a development client application, parses the developer package to generate data contract metadata, modifies a data contract metadata store in accordance with at least one command received with the developer package, and communicates notification data, when included with the data contract metadata, to a notification service.

### BACKGROUND

Today, computer software is increasingly built from collections of reusable components. The reusable components may include defined “views” of a larger data repository. As a result, users of components and builders of components need to define and share the formats and data structures they use to exchange data. Software developers have developed mechanisms for creating these data interchange agreements, sometimes called “data contracts.”

The agile software development methodologies used in modern software development mean that, in many cases, multiple interconnected software components are being built simultaneously by different teams. As a result, data contracts may be re-defined during a software development lifecycle. A software development lifecycle is a methodological process for planning and performing the analysis, design, development, integration and testing, deployment, and maintenance activities related to a software system or application.

### BRIEF SUMMARY

Systems and techniques are disclosed for improving the management of data contracts during a software development lifecycle.

Systems for managing data contracts can involve a data contract metadata store, components for interacting with the metadata store to support development tool integration, and interchange features for verified build processes.

In an example method for managing data contracts, a data management system can receive a developer package from a development client application and parse the developer package to generate data contract metadata associated with a data contract. Then, the data management system can modify a data contract metadata store associated with the system in accordance with at least one command received with the package. Relevant information from the data contract metadata can also be communicated to a notification service.

A method for improving the build reliability of a subscriber codebase using a data management system can include querying a data contract metadata store associated with the data management system for an identified version of a data contract that is received as part of a validation request from a subscriber. The identified version of the data contract can be retrieved and the integrity of the identified version of the data contract can be verified against a subscriber codebase. The results of the verification can then be communicated to the subscriber.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an example component environment in which some implementations may be carried out.

FIG. 2 shows an example process flow for controlled management of data contracts during a development process.

FIG. 3 shows an example process flow for improving the build reliability of a subscriber codebase.

FIG. 4 shows an example representation of a data contract metadata store that may be used to store some properties of data contracts.

FIG. 5 shows a block diagram illustrating components of a computing device or system used in some implementations.

FIG. 6 illustrates an example system architecture in which an implementation of techniques for data contract management may be carried out.

### DETAILED DESCRIPTION

Systems and techniques are disclosed for improving the management of data contracts during a software development lifecycle. “Data contracts” are the prescribed interchange formats or data structures an entity that publishes a data set and an entity that subscribes to a data set agree to use to exchange the data set.

In a software development team, some software developers may focus on building reusable data set components and others may focus on building applications or software that use those components. The reusable data set component can be referred to as a “publisher” or “an entity that publishes a data set,” and the application or software that uses and/or reuses the component can be referred to as a “subscriber” or “an entity that subscribes to a data set.”

The data contract is the manner by which the subscriber knows how to interpret the form of the data to be received from the publisher. The content of the data itself (that is communicated between a publisher and a subscriber) may be constantly in flux (e.g., changes from moment to moment), but the format (or language) of interchange is “agreed” not to change. A data contract may include data type rules, such as whether a particular data field is returned as a number or as a string of alphanumeric characters. A data contract may also include an element hierarchy between data entities, for example, representing that an “order” may contain one or more “items of inventory,” as well as a “subtotal,” “tax,” and “shipping charges.” A data contract may also include explicit constraints on the data to be returned that are not evident in the data type itself—for example, that a numeric field will never be a negative number.

In a common scenario, a “publisher” makes a data set available to subscribers by defining a subset of data from a larger and more complex collection of data. The publisher often processes and refines the raw data in a more usable way, then packages the refined data into a reusable software component or library that may be referenced by one or more subscribers. The subscribers are applications or other software that reuse the data sets. The data contract between the parties constitutes a specific set of rules that publisher and subscribers agree to abide by in sharing data.

A particular data contract may be defined or described in multiple ways. One way of describing a data contract is through commands described using Interface Description Language (IDL). IDL is a programming-language-independent specification language a publishing component may use to allow subscribing components to understand its functional capabilities. Subsets of IDL descriptors may be specifically targeted at data contracts. Data contracts may also be described in Extensible Markup Language (XML) descriptors in accordance with an agreed-upon XML Schema Definition (XSD). In some cases, data contracts may be extracted from the XSD format generated from an XML-capable database when it returns a data set in response to a query. This extraction may be an automated process which in some cases is performed by an application that assists a software developer to do software development tasks. An aspect of the disclosed techniques is that they may allow data contracts described in a variety of formats to be stored in a common metadata repository.

However, often during a software development lifecycle, the publisher of a dataset and subscribers to the dataset are being developed and modified simultaneously. The publisher may modify the data contract during development, causing subscribers to experience errors when being recompiled or at run time. Such errors are time-consuming and wasteful of resources, especially in the later stages of the software development lifecycle; often, the errors go undiscovered until production.

Aspects of the described techniques include a data contract metadata store, components for interacting with the metadata store to support development tool integration, and interchange features for verified build processes. The described techniques may enhance a publisher's ability to communicate changes in data contracts to interested parties (“stakeholders”) and/or to manage the workflow of data contract revision approval by integrating with software development lifecycle services. In some environments where the described techniques are integrated into a software development lifecycle build process, simplified and more efficient software development may be achieved. Certain techniques may also improve the reliability of component systems and reduce the number of errors experienced in live production systems. The described techniques and resulting managed repository of “known verified” data contracts can also benefit data subscribers. In some cases, the techniques may facilitate data contract interchange with other systems and enable tools that provide easier discovery of data set publications.

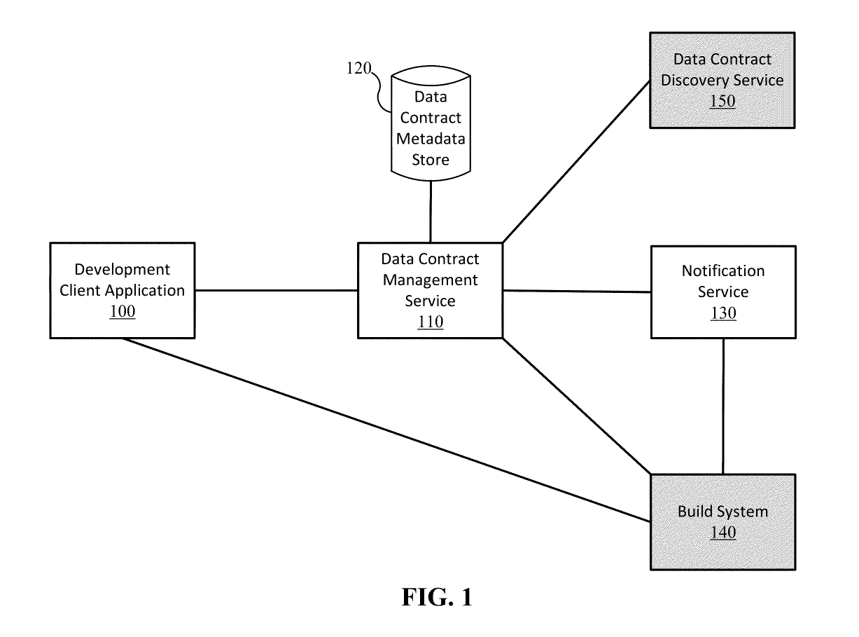

FIG. 1 shows an example component environment in which some implementations may be carried out. Referring to FIG. 1, an example component environment may include a development client application 100, data contract management service 110, data contract metadata store 120, notification service 130, build system 140, and data contract discovery service 150.

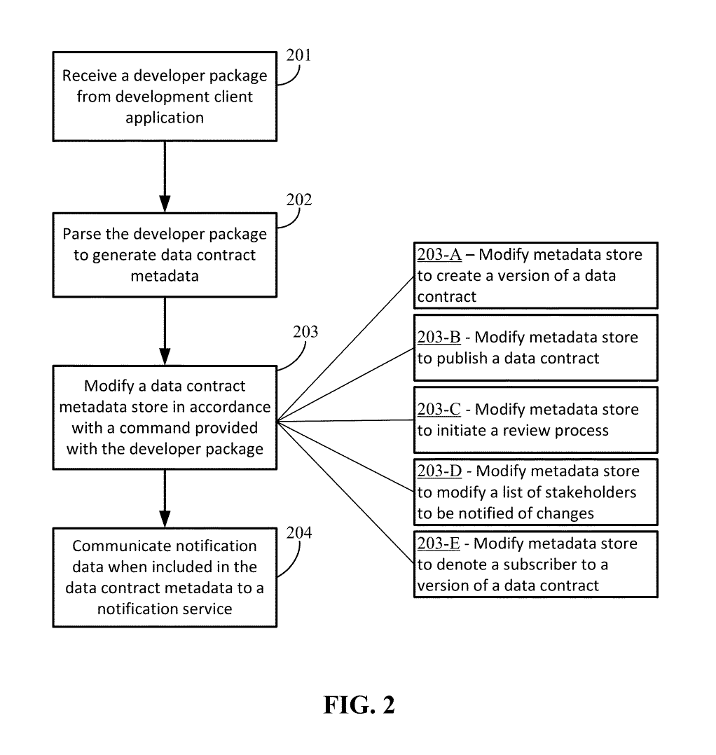

Data contract management service 110 may execute one or more operations, including those described below with respect to FIG. 2. A data contract management service 110 may be accessible to a development client application 100 in order to carry out some of the techniques described herein, including receiving requests from a development client application 100 with respect to data contracts.

A request to the data contract management service 110 may include both a command to the data contract management service 110 and a “development package” generated by the development client application 100; the package contains sufficient information to generate a data contract definition. The information may include the source code itself, containing method definitions or parameters or in-place code descriptors. The information may also include a data contract written in a special description language, such as IDL. The information may also include the bindings or connections of development components to a data repository.

Requests to the data contract management service 110 from the development client application 100 may occur via an Application Programming Interface (API), such as described below with respect to FIG. 6.

A development client application 100 enables a software developer to write software code that describes the operative functions of computer software. A development client 100 is sometimes referred to as an integrated development environment, or IDE. Examples of a development client application 100 include Microsoft Visual Studio®, Apple Xcode®, Eclipse from Eclipse Foundation, or Embarcadero® Delphi®.

Development client application 100 can provide an editing interface through which a user may describe a data contract for a publisher component, for example by using IDL or another technique. Development client application 100 can also provide an interface through which a user may subscribe to a publisher's component. In some cases, development client application 100 may be a stand-alone application operative to initiate operations with respect to a data contract as described herein. The development client application 100 may be as simple as a “command line” tool that operates on a package resulting from a larger build process. In some cases, the command line tool can be a targeted data contract tool having operations that may be integrated into a build process through, for example, parameterized commands called by an IDE or calling development client application.

Another operation of the data contract management service 110 is to interact with data contract metadata store 120 to record, index, and update metadata relating to the data contract.

Data contract metadata store 120 may be any system or component capable of acting as a metadata store for information related to the data contracts.

While the term “data” usually refers to information that is directly usable to an application or person, “metadata” refers to data about data. Metadata generally directs a process to the location of data, or stores additional context information about the data, such as the last time it was updated. For example, the words in a simple text file are its data, but the “modified time” on the file is part of its metadata.

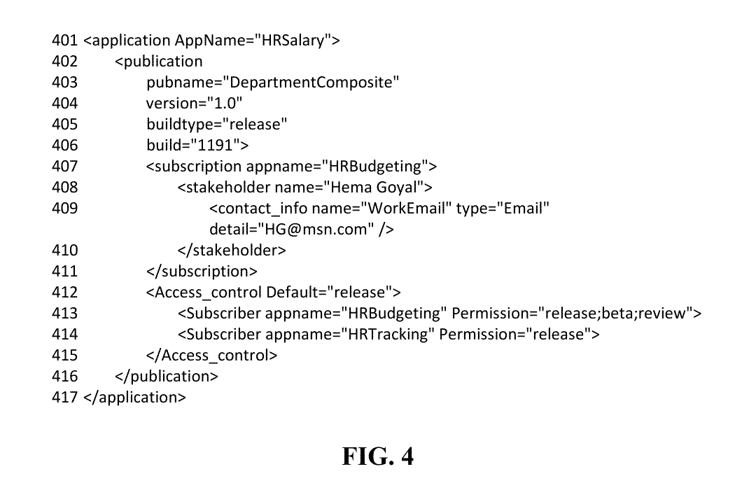

A metadata store may be any structure that can be used to retain information about the location or other properties of data. A metadata store may be embodied in a file, database, document, or even a simple list of key-value pairs. In some cases, the metadata store 120 for data contract metadata can be a database having one or more tables, indexes, stored query definitions, and other elements residing in a database management system (DBMS). In some cases, the metadata store 120 can be as basic as a single extensible markup language (XML) file containing tags. An example XML metadata store for data contract metadata is described below with respect to FIG. 4. Other methods for enabling a metadata store are of course possible.

The data contract management service 110 may interact with a notification service 130. In some cases, the notification service 130 may be a software development lifecycle (SDLC) service, application, or component suite. An SDLC service may provide services related to software product development, facilitating code management, project management, and team communication of development-related activities. An SDLC service may encompass requirements management, software architecture, computer programming, software testing, software maintenance, change management, continuous integration, and release management. Some examples of commercial SDLC services are Microsoft Team Foundation Server®, SAP® Solution Manager, and CA Technologies Endevor®.

In some cases, notification service 130 may be a service that performs more limited or fewer functions with respect to data contract management than the full suite of services provided by a commercial SDLC. For example, notification service 130 may serve as a task management system or communications mechanism for notifying software development team members or other stakeholders of new versions of data contracts. As another example, notification service 130 may implement or facilitate a review and approval system to certify changes to the data contract.

A build system 140 may also be present in some implementation environments to facilitate build activities involved in software development. A build system 140 may automate compilation, testing, deployment, and documentation steps associated with building a software product. A development client application 100 may also interact with a build system 140. An example of a build system is Microsoft Team Build®.

In some cases, as for example when a subscribing component is being built to use a publishing component, data contract management service 110 may be contacted by a development client application 100 to initiate the retrieval of the latest version or of a specific version of a data contract. Data contract management service 110 may interact with build system 140, for example, by placing the requested version of the data contract in a location so that it may be processed by a build stage of the build system 140. The development client application 100 may then interact with build system 140 to execute various build stages, including integrating a data contract provided by the data contract management service 110 to the build system 140.

A build stage is a step in the process of the integrity checking, repackaging, or assembly of code, resources, and other information into a form executable by a processing system. For example, a build stage can include compilation of a codebase (a collection of one or more code files or modules). A build stage may also include automated tests or other validation steps.

In one build stage, the development client application 100 may initiate specific commands in the build system 140. The build stage may verify that a publisher has not broken its established data contracts with the subscriber. A build stage to verify a data contract may be at various temporal locations in a build process, including a pre-compilation step, compilation step, or a post-compilation automated test activity.

In some environments, data contract management service 110 may receive requests from a data contract discovery service 150 to provide metadata regarding data contracts. The request may be a search or query to find appropriate data contracts meeting certain parameters, or the request may be a request for metadata pertaining to a particular contract. In response to a request, data contract management service 110 may interact with data contract metadata store 120 to obtain relevant information that data contract management service 110 may communicate with data contract discovery service 150 to facilitate simplified browsing of available data contracts. The data contract discovery service 150 may serve as a repository of data contract information allowing a central browsing functionality for data contracts.

In some implementations, the data contract management service 110 may also support data contracts defined using an extensible IDL (XIDL) formatting language. XIDL enables data contracts to be defined using more general format types, data types, structures, and descriptive language. XIDL may support, for example, the capability of the data contract management service 110 to interpret data contract IDL meeting different standards and specifications emerging from many different types of development client applications across multiple system platforms.

FIG. 2 shows an example process flow for controlled management of data contracts during a development process. A data contract management service 110, such as described above with respect to FIG. 1, may implement the process. Referring to FIG. 2, a developer package may be received from a development client application (201). This request may be initiated by calling an exposed API function of the data contract management service. The API function may, for example, accept a parameter directing the receiver to an accessible file resource location having the development package.

The developer package may then be parsed to generate data contract metadata (202). The data contract metadata can include information about data contract versions, subscribers, publishers, stakeholders, parameters of a build process, or other information relevant to data contract management. The parsing step may be used to extract a data contract definition and/or generate relevant metadata pertaining to the data contract.

The developer package may also include and/or be provided with one or more commands to initiate specific operations relating to the data contract metadata. These commands may be extracted as part of the parsing step (202).

The developer package may contain different relevant metadata depending on the types of commands within the developer package. The manner in which the developer package is parsed may in some cases depend on the types of commands provided with the developer package and on the types of information in the developer package.

For example, in some cases a command or series of commands may be provided with the developer package. In some cases, the developer package can contain one or more specification files containing, for example, IDL relating to the description of the data contract or XSD relating to the data types made available by the publishing component. The developer package may, in some cases, include one or more incremental files as part of a build system build process. Some, or even many, of the files in the build package may be used or disregarded during parsing, depending on the nature of the command relating to the data contract.

Based on the command(s) provided with the developer package, the data contract metadata store may then be modified (203). The data contract metadata store can be accessed and modified in accordance with the command type, the data contract, and/or other information communicated with the developer package. Examples of commands and modifications include, but are not limited to modifying a metadata store to create a version of a data contract (203-A), modifying a metadata store to publish a data contract (203-B), modifying a metadata store to initiate a review process (203-C), modifying a metadata store to modify a list of stakeholders to be notified of changes (203-D), and modifying a metadata store to denote a subscriber to a version of a data contract (203-E). The different command types and related metadata modifications 203-A through 203-E are explored below in more detail.

In some cases, a command to create a “version” of a data contract and description language or other information that describes the data contract may be included in a developer package. In such a case, the metadata store may be modified to denote the creation of a version of a data contract (203-A). For example, when a new version of a data contract is created, such as during a draft or publication command, metadata may be created or updated referencing the new version and creating context for its lineage using build numbers, timestamps, and/or other information.

In general, a “data contract version” refers to an iteration of a data contract that differs from former or subsequent data contracts having the same publisher and/or data sources. Different subscribers may use or expect to use different versions of a data contract. In some cases, mechanisms are provided for associating metadata to data contract versions so that the subscriber usage is tracked and managed. One of the benefits of certain implementations of the proposed techniques is to enable the tracking of data contract versions so that the exact lineage of any data contract may be traced, and so that the subscribers to any individual data contract version may be known with precision.

In some cases, the version created may be a “draft version.” Draft versions of data contracts are particular instances of data contract versions. A publishing component may make a draft version of a data contract available to selected subscribers so that both publisher and subscriber components may be designed and coded concurrently by different teams. Various “beta” builds of the publishing component may be released as draft versions. Marking a data contract as a “draft” version may also enable notification mechanisms that inform the subscriber's development team of detailed changes in the draft contract as it is being developed, or of other information such as project-management timelines or stages of interest. The “draft” version marker may also allow various subscriber-stakeholders to review and comment on the data contract draft version.

In some cases, a command to “publish” a version of a data contract and description language or other information that describes the data contract may be included in a developer package. In such a case, the metadata store may be modified to denote the publication of a version of a data contract (203-B).

Publication of a version may be a more formal activity than an incremental or draft version, indicating to subscribers that a particular project milestone has been passed or that the data contract has greater reliability or stability than do other versions. Publication may also indicate that backward-compatibility of that version of the data contract will be guaranteed for a time.

It should be noted that various implementations of the disclosed techniques enable data contract version metadata that is rich and varied. Recording version-related information on data contracts enables the use of a variety of statuses and version markers that relate to numerous incremental stages of development and production. Modification of the metadata store to publish a version of a data contract (203-B) may include creating or modifying such statues and version markers. Any of this information may be communicated to a notification system or build system to be integrated into SDLC processes. Therefore, “publication” and “draft” should not be interpreted as limiting of the variety of contract versions.

In some cases, a command to initiate a “review process” for a data contract or other information that describes the data contract may be included in a developer package. In such a case, the metadata store may be modified to denote the data contract as having a review status (203-C).

The review process may include communication of data contract revisions to stakeholders who need to sign-off on modifications to the data contract. In the case of initiating a review process, the update to the metadata store may involve, for example, setting a hold status so that subscribers may not retrieve a new version of a data contract until stakeholder approval has been completed. A review process may be integrated into a notification service having software development lifecycle capabilities as described above.

In some cases, a command to modify a list of stakeholders to be notified by a notification service about changes to the data contract may be included in a developer package. In such a case, the data contract metadata store may be modified to reflect different stakeholders or different stakeholder information in accordance with such a command (203-D).

This list of stakeholders may be stored in the data contract metadata store in association with the data contract. The list may also contain contact information or other details. In some cases, the list of users to be notified may differ in accordance with the data contract version. The updated list may be in some cases communicated to a notification service to manage the communication as part of an SDLC process.

In some cases, a command to retrieve a particular version of a data contract may be included in a developer package. In such a case, the data contract metadata store may be modified to record that, for example, a new subscriber has been associated with the requested version of the data contract (203-E). Retrieving a version of a data contract for a subscriber may involve a modification of the metadata store so that the subscriber is logged as needing notification of changes to the data contract in the future. In some cases, the version requested may be the most current version. In other cases, it may be a draft version, incremental version, beta version, release version, or other version, depending on the nature of the subscriber. In some cases, a subscriber component requesting the data contract may be automatically added to a notification list for future interactions and communication with a notification service.

In some cases, subscriber access permissions may be associated with potential or existing subscriber components to refine, control, or prohibit retrieval or use of data contract versions. This may be associated with an access control list (ACL) stored within the data contract metadata store. For example, a subscriber may only be permitted to subscribe to released or published versions, rather than to beta versions or incremental versions. Some potential subscribers may not be allowed to retrieve and use a data contract at all, thereby prohibiting access to the publishing component's capabilities. In some cases, view access may be restricted.

It should be noted that the examples (203-A through 203-E) described above are specific non-limiting embodiments of modifications that may be made to a data contract metadata store and are not intended to limit the available modifications to only those modifications.

Relevant information about the data contract may then be communicated to notification service (204). Depending on the nature of the modifications and the nature of the notification service, various notification data may be communicated to the notification service, including the data contract itself and the data contract metadata. Notification data communicated to the notification service may include the particular stakeholders to notify. In some cases, such data (the particular stakeholders to notify) is specified by the developer (e.g., as the particular set of required reviewers of changes to the data contract metadata). For example, a developer package may indicate a change to the data contract metadata and specify a set of required viewers of this change (or changes) to the data contract metadata. Thus, when the contract metadata associated with a data contract is generated and the command executed (203), information about who to be notified (e.g., the required viewers) can be sent to a notification service (204).

Optionally, in some cases, people interested in knowing that a change has occurred in the metadata (but who were not specified in the set of required viewers) can also receive a notification. A mechanism can be available through which such interested people may include themselves as part of a list to receive notifications (e.g., either at the notification service or as part of the data contract management service). Then when a change to the data contract metadata occurs, any reviewers indicated by the developer as well as any interested people (included on the list to receive notifications) can receive a notification via the notification service. As noted above with respect to FIG. 1, a notification service may interact with a build system to make operative one or more of other functions, such as development task scheduling or build testing or validation steps.

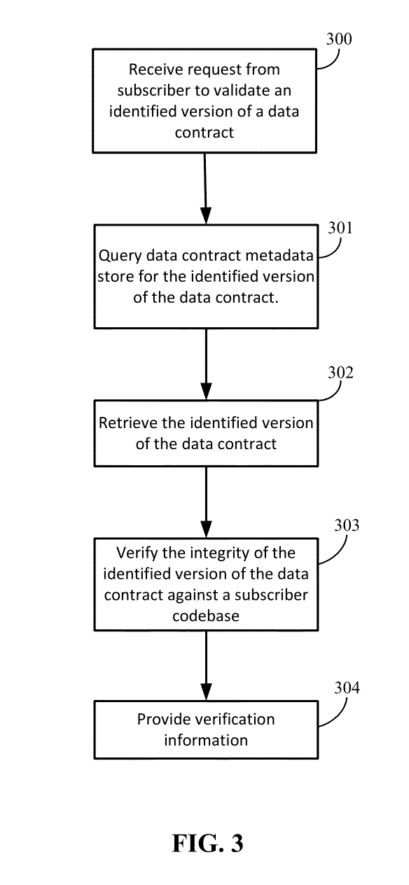

FIG. 3 shows an example process flow for improving the build reliability of a subscriber codebase. A data contract management service 110, such as described above with respect to FIG. 1, may implement the process. Referring to FIG. 3, a request may be received from a subscriber to validate an identified version of a data contract (300). The request may be a validation request to verify that the subscriber is in accordance with a particular version of a data contract. One method a subscriber may use to send the request is via a development client application used by a developer to build a subscriber. In some cases, this request may be initiated by calling an exposed API function of the data contract management service.

In response to the request, the data contract management service may query a data contract metadata store for the version of a data contract (301). The version of the data contract may be the most current version, a release version, intermediate or beta version, or any of the other available versions. By accessing the data contract metadata store, the data contract management service may be able to retrieve a specific version of the data contract from the metadata store (302).

The integrity of the version of the data contract may then be verified against a subscriber codebase (303). A data contract management service, in some cases in concert with a build system 140 as shown in FIG. 1, may use the retrieved version of the data contract and coordinate build processes with the build system for the subscriber component codebase.

Certain integrity verification checks may be performed to ensure that the version of the data contract indicated is the same as the one expected by the subscriber codebase. Verifying the integrity of the version of the data contract against the subscriber codebase may be performed in various ways. For example, compilation stages may match and compare expected data types and data elements to the data types, data elements, data hierarchies, and constraints described in the new version of the data contract. In some cases, a data contract management service may coordinate with a build system to execute automated test processes to ensure that functions of the subscribing component still execute normally or properly after the retrieval of the new data contract version.

Once the verification process(es) is completed, the results can be provided (304). Responses indicating the results of the verification processes may be communicated to the subscriber. The manner in which verification information is communicated may vary according to implementation. For example, in some cases build errors may be communicated to the development client application being used to develop the subscriber. In other cases, for example when lengthy test processes need to be performed, the response may be communicated to a notification service for further action. In other cases, the response may be communicated to a build system. Likewise, the content of the verification information may vary according to result. For example, an unsuccessful verification may result in an extensive list of errors or mismatches being communicated in the response, while a successful result may require that different or less information be communicated.

Similar to the case mentioned with respect to the process illustrated in FIG. 2, for the process illustrated in FIG. 3, in some cases, subscriber access permissions may be associated with potential or existing subscriber components to refine, control, or prohibit linkages to publishers. This may be associated with an ACL stored within the data contract metadata store. For example, a subscriber may only be permitted to subscribe to released or published versions, rather than to beta versions or incremental versions. Some potential subscribers may not be allowed to retrieve and use a data contract at all, thereby prohibiting access to the publishing component's capabilities. In some cases, view access may be restricted.

FIG. 4 shows an example representation of a data contract metadata store that may be used to store some properties of data contracts. FIG. 4 contains hierarchical XML tags and elements appropriate for storing metadata related to a data contract's publications, versions, stakeholders, and other information. One level of nested tags and elements in the XML file represents information about a publishing application. In particular, beginning on line 401 (closing at line 417), the representation recites <application AppName=“HRSalary”> to indicate the name of the publishing application as ‘HRSalary”. The application level has numerous sub-tags describing various components and properties, shown at lines 402-406.

In one nested element of the publishing application, publications of data contracts are described (beginning on line 402 and closing at line 416). The publication has various properties, describing such information as the version, name, build number and other details. In the example shown at lines 403-406, properties such as the name of the XML publication (“pubname”), version, build type, and build are described.

Multiple publications are possible using multiple publication tags, spanning different version numbers, release and incremental builds. Properties associated with the publication depict the kinds of metadata that may be tracked in a given implementation. Further inside the nested element structure, a publisher may have one or more subscriptions to a given publication. For example, as shown at lines 407-411, a subscription is defined for “HRBudgeting”. Metadata associated with the subscribing application may be stored (e.g., line 407). In turn, each subscription may have multiple associated stakeholders, defined at the subscription level, who need to be notified of modifications (for example, stakeholder “Hema Goyal” at line 408). Each stakeholder may have multiple contact methods. In the example shown at line 409, an email address is provided for the stakeholder.

Moving back to the publication level, access control properties may be stored about a given publication. The access control properties may determine which potential subscriber applications are allowed to view or subscribe to particular types of publication builds. For example, a publishing application may publish both release builds and beta builds. Some subscribers may be allowed to use only release builds (line 414), while other subscribers are allowed to use beta builds as well (line 413).

Practitioners in the art will appreciate that an XML metadata store having the disclosed aspects may be implemented in multiple ways. Thus, the example XML metadata store depicted in FIG. 4 is not intended to be limiting to a particular content or arrangement of tags and elements.

In one embodiment of systems and techniques described herein, a data contract management service, data contract metadata store, notification service, build system, and contract management client application are present. In an implementation of such an embodiment, data contract management service can receive requests from the contract management client application to perform various contract management activities. Data contract management service can also update the data contract metadata store and interact with a notification service to obtain approval workflows and to enact notification of stakeholders.

One request from the contract management client may be to initiate a contract review process. In response the data contract management service may communicate with a notification service operative as an SDLC service to obtain approval workflows by which the new version of the data contract may be certified. In some cases, the approval process may include code reviews coordinated by the SDLC or other project planning activities.

Another request to the data contract management service from the contract management client application may be to obtain the latest version or a specific version of a contract from a build system. In the above described implementation, the data contract definition (e.g., IDL or XSD file) may be stored within the code repository of a build system. Data contract management service may retrieve the version of the data contract from the build system and transfer or direct the contract management client application to the data contract definition.

Other requests to the data contract management service may include creating a draft contract, publishing a contract, revising a contract, and notifying subscribers of the availability of newer versions of contracts. Data contract management service may modify the data contract metadata store in response to these requests and may communicate with the notification service so that it may inform stakeholders of changes and updates.

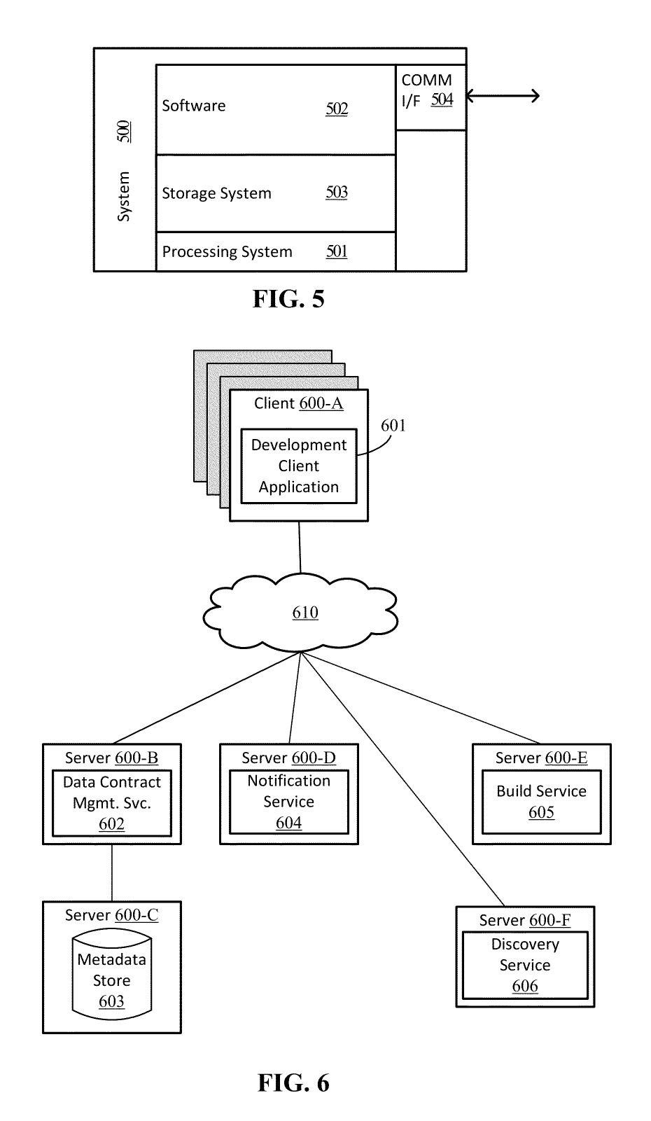

FIG. 5 shows a block diagram illustrating components of a computing device or system used in some implementations. For example, any client computing device operative to run a development client application 100, data contract management service 110, server containing a metadata store 120, notification service 130, build system 140, data contract discovery service 150 (from FIG. 1), or intermediate devices facilitating interaction between other devices in the environment, may each be implemented as described with respect to system 500, which can itself include one or more computing devices. The system 500 can include one or more blade server devices, standalone server devices, personal computers, routers, hubs, switches, bridges, firewall devices, intrusion detection devices, mainframe computers, network-attached storage devices, and other types of computing devices. The server hardware can be configured according to any suitable computer architectures such as a Symmetric Multi-Processing (SMP) architecture or a Non-Uniform Memory Access (NUMA) architecture.

The system 500 can include a processing system 501, which may include a processing device such as a central processing unit (CPU) or microprocessor and other circuitry that retrieves and executes software 502 from storage system 503. Processing system 501 may be implemented within a single processing device but may also be distributed across multiple processing devices or sub-systems that cooperate in executing program instructions.

Examples of processing system 501 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system 503 may comprise any computer readable storage media readable by processing system 501 and capable of storing software 502. Storage system 503 may include volatile and nonvolatile, removable and non-removable media implemented in any method or technology for storage of information, such as computer readable instructions, data structures, program modules, or other data.

Examples of storage media include random access memory (RAM), read only memory (ROM), magnetic storage (e.g., disks, tapes, devices), optical storage (e.g., disks, devices), CDs, DVDs, flash memory, phase change memory, or any other suitable storage media. Certain implementations may involve either or both virtual memory and non-virtual memory. In no case do storage media consist of a propagated signal. In addition to storage media, in some implementations storage system 503 may also include communication media over which software 502 may be communicated internally or externally.

Storage system 503 may be implemented as a single storage device but may also be implemented across multiple storage devices or sub-systems co-located or distributed relative to each other. Storage system 503 may include additional elements, such as a controller, capable of communicating with processing system 501.

Software 502 may be implemented in program instructions and among other functions may, when executed by system 500 in general or processing system 501 in particular, direct system 500 or processing system 501 to operate as described herein for enabling data contract management. Software 502 may provide program instructions that implement a data contract management service, data contract metadata store, and/or development client application. Software 502 may implement on system 500 components, programs, agents, or layers that implement in machine-readable processing instructions the methods described herein as performed by the data contract management service, notification service, data contract metadata store, and/or development client application.

Software 502 may also include additional processes, programs, or components, such as operating system software or other application software. Software 502 may also include firmware or some other form of machine-readable processing instructions executable by processing system 501.

In general, software 502 may, when loaded into processing system 501 and executed, transform system 500 overall from a general-purpose computing system into a special-purpose computing system customized to facilitate data contract management. Indeed, encoding software 502 on storage system 503 may transform the physical structure of storage system 503. The specific transformation of the physical structure may depend on various factors in different implementations of this description. Examples of such factors may include, but are not limited to, the technology used to implement the storage media of storage system 503 and whether the computer-storage media are characterized as primary or secondary storage.

System 500 may represent any computing system on which software 502 may be staged and from where software 502 may be distributed, transported, downloaded, or otherwise provided to yet another computing system for deployment and execution, or yet additional distribution.

It should be noted that many elements of system 500 may be included in a system-on-a-chip (SoC) device. These elements may include, but are not limited to, the processing system 501, a communications interface 504, and even elements of the storage system 503 and software 502.

In embodiments where the system 500 includes multiple computing devices, one or more communications networks may be used to facilitate communication among the computing devices. For example, the one or more communications networks can include a local, wide area, or ad hoc network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 504 may be included, providing communication connections and devices that allow for communication between system 500 and other computing systems (not shown) over a communication network or collection of networks (not shown) or the air. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

FIG. 6 illustrates an example system architecture in which an implementation of techniques for data contract management may be carried out. In the example illustrated in FIG. 6, a development client application 601 can be implemented on a client device 600-A, which may be a particular instantiation of a system 500 as described with respect to FIG. 5 and may be or include computing systems such as a laptop, desktop, tablet, mobile phone, and the like. Many development client applications may be present in a given environment (represented by the gray shadow boxes behind 600-A).

A data contract management service 602 may be implemented as software or hardware (or a combination thereof) on server 600-B, which also may be an instantiation of system 500. The data contract management service 602 may direct metadata store changes to an appropriate metadata store 603, which may be implemented on server 600-C (which may itself be an instantiation of system 500 or aspects thereof).

A notification service 604 may be implemented as software or hardware (or a combination thereof) on server 600-D, which also may be an instantiation of system 500. Notification service 604 may receive communication from data contract management service 602 and interact with other system components as described above.

In some implementations, a build service 605 and data contract discovery service 606 may be present. These components may be implemented as software or hardware (or a combination thereof) on servers 600-D and 600-F respectively, each of which also may be an instantiation of system 500. Capabilities described as operative in a build service 605 or discovery service 606 may in some cases be available as separate components or services.

Communications and interchanges of data between components in the environment may take place over network 610. The network 610 can include, but is not limited to, a cellular network (e.g., wireless phone), a point-to-point dial up connection, a satellite network, the Internet, a local area network (LAN), a wide area network (WAN), a WiFi network, an ad hoc network, an intranet, an extranet, or a combination thereof. The network may include one or more connected networks (e.g., a multi-network environment) including public networks, such as the Internet, and/or private networks such as a secure enterprise private network.

The features and functions of a data contract management service 602 may be callable by a development client application 601 through an API. Indeed, any or all of the interactions between environmental components herein may be initiated and performed as API calls. An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture. The API and related components may be stored in one or more machine-readable storage media (e.g., storage media such as hard drives, magnetic disks, solid state drives, RAM, flash, CDs, DVDs and the like).

FIG. 6 shows system components operative on separate devices 600-A through 600-F. It should be noted, however, that any number of and even all of the software components described above as development client application 601, data contract management service 602, metadata store 603, notification service 604, build service 605 and discovery service 606 need not be run on separate devices, and may indeed be run on the same device.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Certain aspects of the invention provide the following non-limiting embodiments:

### Example 1

A method for managing data contracts for publishers and subscribers developed via software development applications, the method comprising: parsing a developer package to generate contract metadata associated with a data contract; modifying a data contract metadata store in accordance with at least one command received with the developer package; and providing notification data, when included with the data contract metadata, to a notification service.

### Example 2

The method of example 1, wherein the at least one command comprises a command to create a new version of the data contract.

### Example 3

The method of example 2, wherein the new version is indicated as a draft version.

### Example 4

The method of any of examples 1-3, wherein the at least one command comprises a command to publish the data contract.

### Example 5

The method of any of examples 1-4, wherein the at least one command comprises a command to initiate a review process for the data contract.

### Example 6

The method of any of examples 1-5, wherein the at least one command comprises a command to modify a list of stakeholders to be notified about changes to the data contract metadata.

### Example 7

The method of any of examples 1-6, wherein the at least one command comprises a command to retrieve an identified version of a data contract.

### Example 8

The method of example 7, wherein modifying the data contract metadata store in accordance with the at least one command received with the developer package comprises denoting the identified version of the data contract as having a particular subscriber.

### Example 9

The method of any of examples 1-8, wherein the notification service is a software development lifecycle service.

### Example 10

The method of any of examples 1-9, wherein the notification data comprises an indication of required reviewers and optionally, contact information for the required reviewers.

### Example 11

The method of any of examples 1-10, wherein the notification data comprises an indication that a change to the data contract was made.

### Example 12

One or more computer-readable storage media having instructions stored thereon, that when executed by a processing system, direct the processing system to perform the method according to any of examples 1-11.

### Example 13

A method for improving the build reliability of a subscriber codebase, the method comprising: receiving a request from a subscriber to validate an identified version of a data contract; querying a data contract metadata store for the identified version of the data contract; verifying an integrity of the identified version of the data contract against a codebase for the subscriber; and providing verification information indicating the integrity of the identified version of the data contract.

### Example 14

The method of example 13, wherein the verifying the integrity of the data contract comprises a build stage of a build system.

### Example 15

The method of example 14, wherein the build stage is a compilation stage.

### Example 16

The method of example 14, wherein the build stage is an automated test stage.

### Example 17

One or more computer-readable storage media having instructions stored thereon, that when executed by a processing system, direct the processing system to perform the method according to any of examples 13-16.

### Example 18

A system for managing data contracts, the system comprising: one or more storage media; at least one data contract metadata store contained on at least one of the one or more computer readable storage media, the at least one data contract metadata store having data contract metadata comprising: one or more properties related to a data contract version; one or more properties related to a subscriber; and one or more properties related to one or more stakeholders for notification; and program instructions stored on at least one of the one or more computer readable media that, when executed by a processing system, direct the processing system to: parse a developer package to generate contract metadata associated with a data contract; modify the data contract metadata store in accordance with at least one command received with the developer package; and provide notification data, when included with the data contract metadata, to a notification service.

### Example 19

The system of example 18, wherein the data contract metadata further comprises an access control list for controlling a subscriber access permission.

### Example 20

The system of any of examples 18-19, wherein the data contract metadata store communicates with a data contract discovery service.

### Example 21

The system of any of examples 18-20, wherein the at least one command comprises one or more commands selected from the group consisting of: a command to create a new version of the data contract; a command to publish the data contract; a command to initiate a review process for the data contract; a command to modify a list of stakeholders to be notified about changes to the data contract metadata; and a command to retrieve an identified version of a data contract.

### Example 22

The system of example 21, wherein, in response to receiving the command to create the new version of the data contract, the program instructions direct the processing system to modify at least one of the one or more properties related to the data contract version.

### Example 23

The system of any of examples 21-22, wherein, in response to receiving the command to retrieve the identified version of the data contract, the program instructions direct the processing system to modify at least one of the one or more properties related to the subscriber to denote a particular subscriber.

### Example 24

The system of any of examples 21-23, wherein, in response to receiving the command to modify the list of stakeholders to be notified about changes to the data contract metadata, the program instructions direct the processing system to modify at least one of the one or more properties related to the one or more stakeholders for notification, wherein the notification data comprises at least one of the one or more properties related to one or more stakeholders for notification.

### Example 25

The method of any of examples 18-24, wherein the notification service is a software development lifecycle service.

### Example 26

The system of any of examples 18-25, wherein the notification data comprises an indication of required reviewers and optionally, contact information for the required reviewers.

### Example 27

The method of any of examples 18-26, wherein the notification data comprises an indication that a change to the data contract was made.

It should be understood that the examples and embodiments described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method for managing data contracts for publishers and subscribers developed via software development applications, the method comprising:
parsing a developer package to generate contract metadata associated with a data contract;
modifying a data contract metadata store in accordance with at least one command received with the developer package; and
providing notification data, when included with the data contract metadata, to a notification service.

2. The method of claim 1, wherein the at least one command comprises a command to create a new version of the data contract.

3. The method of claim 2, wherein the new version is indicated as a draft version.

4. The method of claim 1, wherein the at least one command comprises a command to publish the data contract.

5. The method of claim 1, wherein the at least one command comprises a command to initiate a review process for the data contract.

6. The method of claim 1, wherein the at least one command comprises a command to modify a list of stakeholders to be notified about changes to the data contract metadata.

7. The method of claim 1, wherein the at least one command comprises a command to retrieve an identified version of a data contract.

8. The method of claim 7, wherein modifying the data contract metadata store in accordance with the at least one command received with the developer package comprises denoting the identified version of the data contract as having a particular subscriber.

9. The method of claim 1, wherein the notification service is a software development lifecycle service.

10. A method for improving the build reliability of a subscriber codebase, the method comprising:
receiving a request from a subscriber to validate an identified version of a data contract;
querying a data contract metadata store for the identified version of the data contract;
verifying an integrity of the identified version of the data contract against a codebase for the subscriber; and
providing verification information indicating the integrity of the identified version of the data contract.

11. The method of claim 10, wherein the verifying the integrity of the data contract comprises a build stage of a build system.

12. The method of claim 11, wherein the build stage is a compilation stage.

13. The method of claim 11, wherein the build stage is an automated test stage.

14. A system for managing data contracts, the system comprising:
one or more storage media;
at least one data contract metadata store contained on at least one of the one or more computer readable storage media, the at least one data contract metadata store having data contract metadata comprising:
one or more properties related to a data contract version;
one or more properties related to a subscriber; and
one or more properties related to one or more stakeholders for notification; and
program instructions stored on at least one of the one or more computer readable media that, when executed by a processing system, direct the processing system to:
parse a developer package to generate contract metadata associated with a data contract;
modify the data contract metadata store in accordance with at least one command received with the developer package; and
provide notification data, when included with the data contract metadata, to a notification service.

15. The system of claim 14, wherein the data contract metadata further comprises an access control list for controlling a subscriber access permission.

16. The system of claim 14, wherein the data contract metadata store communicates with a data contract discovery service.

17. The system of claim 14, wherein the at least one command comprises one or more of:
a command to create a new version of the data contract;
a command to publish the data contract;
a command to initiate a review process for the data contract;
a command to modify a list of stakeholders to be notified about changes to the data contract metadata;
a command to retrieve an identified version of a data contract.

18. The system of claim 17, wherein, in response to receiving the command to create the new version of the data contract, the program instructions direct the processing system to modify at least one of the one or more properties related to the data contract version.

19. The system of claim 17, wherein, in response to receiving the command to retrieve the identified version of the data contract, the program instructions direct the processing system to modify at least one of the one or more properties related to the subscriber to denote a particular subscriber.

20. The system of claim 17, wherein, in response to receiving the command to modify the list of stakeholders to be notified about changes to the data contract metadata, the program instructions direct the processing system to modify at least one of the one or more properties related to the one or more stakeholders for notification,
wherein the notification data comprises at least one of the one or more properties related to one or more stakeholders for notification.
